(19) United States
(12) Patent Application Publication
(10) Pub. No.: US 2014/0002942 A1
(43) Pub. Date: Jan. 2, 2014

(54) Secondary Lithium Ion Battery With Mixed Nickelate Cathodes

(71) Applicant: Boston-Power, Inc., Westborough, MA (US)

(72) Inventors: Yanning Song, Chelmsford, MA (US); Kenneth Avery, Cambridge, MA (US); Richard V. Chamberlain, II, Fairfax Station, VA (US); Per Onnerud, Wilton, CT (US)

(73) Assignee: Boston-Power, Inc., Westborough, MA (US)

(21) Appl. No.: 13/893,918

(22) Filed: May 14, 2013

Related U.S. Application Data
(60) Provisional application No. 61/660,424, filed on Jun. 15, 2012.

(51) Int. Cl. H01M 10/42; H02J 7/00

(52) U.S. Cl. CPC H01M 10/4257; H02J 7/0031
USPC 361/93.1

(57) ABSTRACT

A secondary lithium-ion battery employing a prismatic battery can includes a cathode that includes a mixture of lithium nickel cobalt manganese oxide and a lithium nickel cobalt oxide in a weight ratio of between about 0.20:0.80 and about 0.80:0.20, and a current interrupt device. The cathode and current interrupt device are attenuated to trigger the current interrupt device when a voltage of greater than about 4.2 volts and equal to or less than about 5.0 volts is applied to the secondary lithium battery.

### RELATED APPLICATION(S)

This application claims the benefit of U.S. Provisional Application No. 61/660,424, filed on Jun. 15, 2012. The entire teachings of the above application are incorporated herein by reference.

### BACKGROUND OF THE INVENTION

Safe shutdown of high energy lithium-ion cells under overvoltage charge conditions is critical in real world consumer applications. To facilitate safe shut down, current interruption devices (CID) are widely used in lithium-ion cells. When a lithium-ion cell is under overvoltage charge conditions, the current interrupt device (CID) activates after the cell internal pressure reaches the pre-determined activating pressure. To ensure that a CID will activate before the cell goes into a thermal-runaway condition, chemical agents (also called gassing agents, or overvoltage charge agents) typically are added to the cell's electrolyte that will cause a gas to evolve at a specified overcharge potential, thereby triggering the CID.

Unfortunately most overvoltage charge agents can decompose even at normal operating voltage, albeit at a much lower rate. This will compromise cell performance, especially at elevated temperatures. For example, it has been found that premature reaction of a gassing agent can lead to partial electronic isolation of active materials, resulting in significant fade of battery capacity. Further, the self-discharge rate typically is also expected to be worse under storage when using a gassing agent, leading to a lower calendar life. In some cases, gassing agents prevent the utilization of the full capacity of cathode materials even though the cathode system is stable at high voltage (≧4.3V), such as is the case with some nickel cobalt manganese (NCM), doped lithium cobalt oxide (LCO), layer-layer compound and high voltage spinel cathodes.

To ensure cell safety under abuse conditions, a current interrupt device (CID) is used in the lithium ion cells using the above-mentioned cathode. When the lithium-ion cell is under overvoltage charge conditions, the current interrupt device (CID) activates after the cell internal pressure reaches the pre-determined activating pressure. To ensure that the CID will activate before the cell goes into a thermal-runaway condition, chemical agents (also called gassing agents, or “overcharge agents”) are typically added in the cell's electrolyte. Herein the gassing agent means one or more chemical agents (also called additives) that are mixed in the electrolyte to generate gas at voltages greater than the maximum operating voltage of the cell (that is, overcharge), so as to activate the CID before the cells go to thermal runaway. However, these chemical agents typically will have a negative effect on cell performance, such as, for example cycle life, storage performance, or power capability.

Therefore, a need exists for a secondary lithium-ion battery cell that overcomes or minimizes these limitations.

### BRIEF DESCRIPTION OF THE DRAWINGS

FIG. 1 is a plot of high temperature cycling performance for a lithium ion cell with mixed NCA/NCM cathode chemistry without (A) and with (B) using a gassing agent biphenyl (BP) of 3% in the electrolyte; (C). Using a gassing agent BP of 4.7%

FIG. 2 is a plot of 1 C/20V overvoltage charge responses for cells where a constant current of 1 C is applied to the cell until the cell voltage reaches 20 V. Results are shown for (a) a mixed NCA/NCM cathode with a gassing agent BP in the electrolyte; (b) a mixed NCA/NCM cathode without a gassing agent in the electrolyte; and (c) an NCM cathode without a gassing agent in the electrolyte.

FIG. 3 is a plot comparing a current (electrochemical reaction) and a pressure response in an electrochemical scan of different electrodes in an electrolyte without a gassing agent: (1) an NCA cathode; (2) an NCA/NCM (40/60 wt % ratio.) cathode; and (3) an NCM cathode. The different electrodes were tested in a coin cell battery configuration against a lithium metal counter-reference electrode.

FIG. 4 is a current-voltage scan of electrolyte (A) with biphenyl (BP) gassing agent added at 4.7% by weight, and (B) without any gassing agent added. Measurement performed at Al electrode vs. a Li counter-reference electrode.

FIG. 5 is a plot of (a) room temperature charge-discharge cycling performance of cells having a mixed NCA/NCM cathode (A) and an NCM cathode (B); and (b) high temperature charge-discharge cycling performance cells having a mixed NCA/NCM cathode (A) and an NCM cathode (B).

### SUMMARY OF THE INVENTION

The invention generally is directed to a secondary lithium-ion battery cell that includes an active cathode mixture of lithium nickel cobalt manganese oxide (NCM) and lithium nickel cobalt aluminum oxide (NCA), a method of forming such a lithium-ion battery, a battery pack and a portable electronic device or energy storage system that includes such a battery pack or lithium-ion battery.

In one embodiment, the invention is a secondary lithium-ion battery cell that includes an anode and a cathode, the cathode being electrically insulated from the anode and including a mixture of a lithium nickel cobalt manganese oxide and a lithium nickel cobalt aluminum oxide in a weight ratio of between about 0.20:0.80 and about 0.80:0.20. A battery can of the battery cell of the invention is a prismatic battery can and is in electrical communication with the cathode and a negative terminal is electrically insulated from the battery can. The battery cell of the invention also includes a current interrupt device between the cathode and the battery can, and is in electrical communication with both the cathode and the battery can, wherein the current interrupt device is attenuated to trigger during a sustained overvoltage charge condition applied to the battery cell and before catastrophic thermal runaway occurs, without the presence of a gassing agent in the battery can. In one embodiment, the current interrupt device will trigger when the voltage applied to the battery is greater than about 4.2 and equal to or less than 5.0 volts.

The invention has many advantages. For example, the mixture of lithium nickel cobalt manganese oxide (NCM) and lithium nickel cobalt aluminum oxide (NCA) achieved longer cell cycle life than single NCM, while maintaining battery safety, despite the absence, or minimal presence of a distinct gassing agent. In this invention, it is shown that through novel design of a cell with special consideration as to the nature of the cathode material, CID activation can be accomplished in sufficient time to prevent thermal runaway without the need for a gassing agent or with significantly reduced amount of gassing agent. This enables advantages in the performance of the lithium-ion cell.

### DETAILED DESCRIPTION OF THE INVENTION

The present invention is generally directed to a secondary lithium-ion battery that includes an active cathode material of a mixture of lithium nickel cobalt manganese oxide (NCM) and lithium nickel cobalt aluminum oxide (NCA), a method of forming such a lithium-ion battery, a battery pack comprising one or more cells, each of the cells including such active cathode materials, and a portable electronic device, transportation device or energy storage system that include such a battery pack or lithium-ion battery.

In one embodiment, the present invention is directed to a secondary lithium-ion battery that has an active cathode material that includes a mixture of electrode materials. The mixture includes a lithium nickel cobalt manganese oxide and a lithium nickel cobalt aluminum oxide. The lithium nickel cobalt manganese oxide is represented by the formula of Li(Ni_{0.5}Co_{0.2}Mn_{0.3})O₂, the lithium nickel cobalt aluminum oxide is represented by the formula Li(Ni_{0.8}Co_{0.15}Al_{0.05})O₂. The weight ratio of lithium nickel cobalt manganese oxide to lithium nickel cobalt aluminum oxide is about 60:40. In a related embodiment, the weight ratio of lithium nickel cobalt manganese oxide to lithium nickel cobalt aluminum oxide is in a range of between about 80:20 and 20:80. In another related embodiment, the lithium nickel cobalt manganese oxide is represented by the formula of Li(Ni_{1/3}Co_{1/3}Mn_{1/3})O₂, Li(Ni_{0.6}Co_{0.2}Mn_{0.2})O₂, Li(Ni_{0.7}Co_{0.15}Mn_{0.15})O₂, etc.

Normal cell operation occurs up to a defined voltage range that is a designed characteristic of the cell and dependent on the cathode materials used in the cell. For typical lithium-ion cells, the maximum voltage range will be 4.2 to 4.4 V. A common abuse scenario in applications using batteries is an overvoltage charge condition where malfunction of electronic controls allows for charging more energy into the cell than it is designed to accept. This condition is most easily recognized as charging to greater than the maximum specified voltage of the cell, i.e. >4.2 to 4.4 V. This is defined as an overvoltage charge condition and if sufficient extra energy is charged into the cell then a thermal runaway can occur. The overvoltage charge condition can occur after a very long time (hours to days) if the overcharge current is low (<0.5 C rating of the cell) or it can occur after a relatively short time (minutes to hours) if the overvoltage charge current is high (>0.5 C). Thermal runaway is defined as uncontrolled reaction of the cell as characterized by one or more of rapid heating, smoking, fire and explosion.

It is a critical requirement of safe lithium-ion cells that they be designed with the capability to shutdown, i.e. prevent charging or discharging, in the event of an overvoltage charge abuse condition. This feature is typically accomplished by the use of a CID device that activates during overvoltage charge abuse due to increasing pressure build up inside the cell. Typically, the CID will be triggered at an internal pressure of the cell that is in a range of between 6 pounds per square inch gauge pressure (psig) and about 10 psig. By activating, the CID acts to disconnect, i.e. shutdown, the cell. A critical factor in cells designed with a CID device is that the CID must activate before the overvoltage charge abuse causes cell thermal runaway. Typically, in order to activate the CID in time to prevent thermal runaway, a gassing agent is added to the electrolyte of the cell.

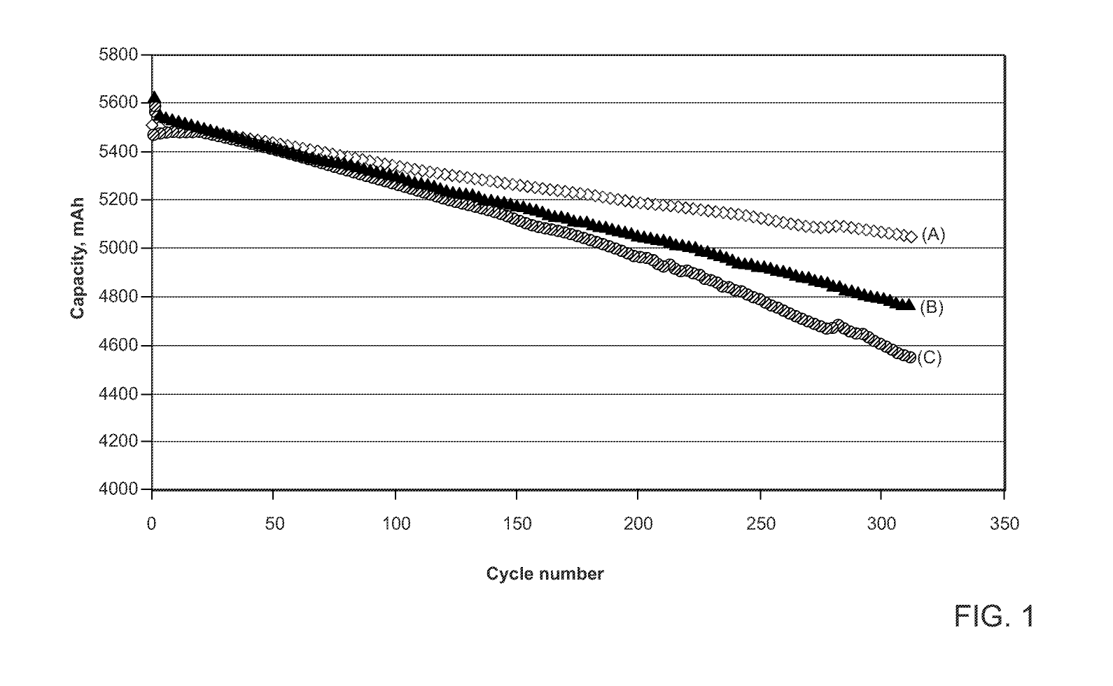

FIG. 1 shows a comparison of the high temperature charge-discharge cycle life for a cell with and without a gassing agent in the electrolyte. Plot (A) is without a gassing agent. Plot (B) is with a gassing agent in an amount of about 3% (by weight) of the electrolyte. Plot (C) is with a gassing agent in an amount of about 4.7% (by weight) of the electrolyte.

In the mixed cathode system of this invention, the cathode material NCA undergoes a decomposition reaction which results in evolution of gas and subsequent activation of the cell's CID during an overvoltage charge condition. NCA will decompose and generate gas, possibly through the following reaction mechanism: LiNi_{0.8}Co_{0.15}Al_{0.05}O₂→Li+0.80NiO₂+0.15CoO₂+0.025Al₂O₃+0.0125O₂. This type of decomposition only happens, or happens to a much greater degree, with NCA, but not LCO, LMO or NCM, since in LCO, LMO and NCM the transition metal (Ni, Co, Mn) can oxidize to the 4+ oxidation state, that is Co⁴⁺, Mn⁴⁺, Ni⁴⁺ and each transition metal in the 4+ state can balance with 2 oxygen, which matches the pre-existing chemical balance. However, in the case of NCA, the maximum oxidation state of aluminum will stay as 3+, and during an overvoltage charge there will be extra oxygen that will release as gas (O₂), as described in the reaction equation above.

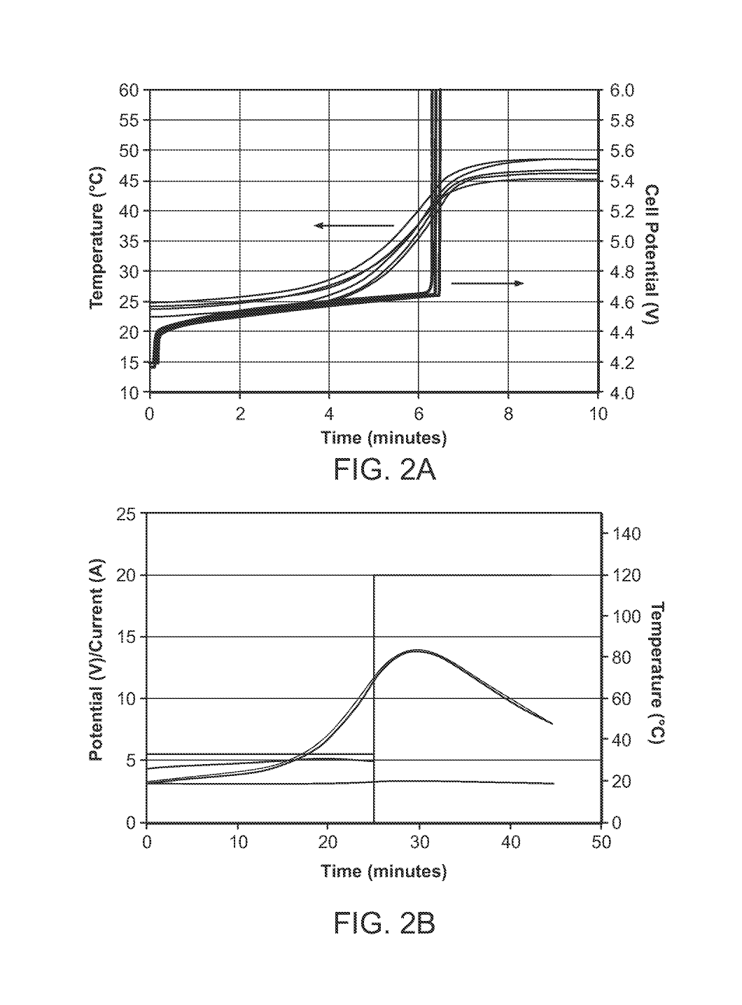

Therefore, the batteries of the invention do not need a gassing agent in the electrolyte to activate the CID in an overvoltage charge condition if the amount of NCA is sufficient to generate gas at the upper limit of safe conditions. For example, for a CID activation pressure of about 10 atm gauge pressure when a cathode system of NCA/NCM 40/60 by weight is used, the calculated internal pressure after NCA decomposition is higher than 20 atm gauge pressure, assuming 100% efficiency, which is sufficient to activate the CID. As shown in FIG. 2a, cells with a mixture of NCA/NCM 40/60 wt. percent passed an overvoltage charge test with a gassing agent FIG. 2b shows the results of the overcharge test employing the same cathode as 2a, but where there was no gassing agent in the electrolyte. FIG. 2b results demonstrate that in this invention the gassing agent in the electrolyte is not required to safely shutdown the cell. By not having a gassing agent or by having lower levels of gassing agent than otherwise required to achieve acceptable safety, the invention enables improved battery performance, especially with respect to life and high temperature operation, as shown in FIG. 1. FIG. 2c shows the results of the overvoltage charge test when NCM is used as the cathode material. The cell cannot generate sufficient gas to activate the CID and shutdown prior to onset of thermal runaway, thus the cell lacks a key safety feature. The same result of thermal runaway has been observed for when the cathode is lithium cobalt oxide (LiCoO₂ (LCO)) and a mixture of LCO/LMO (LMO is lithium manganese oxide spinel, LiMn₂O₄).

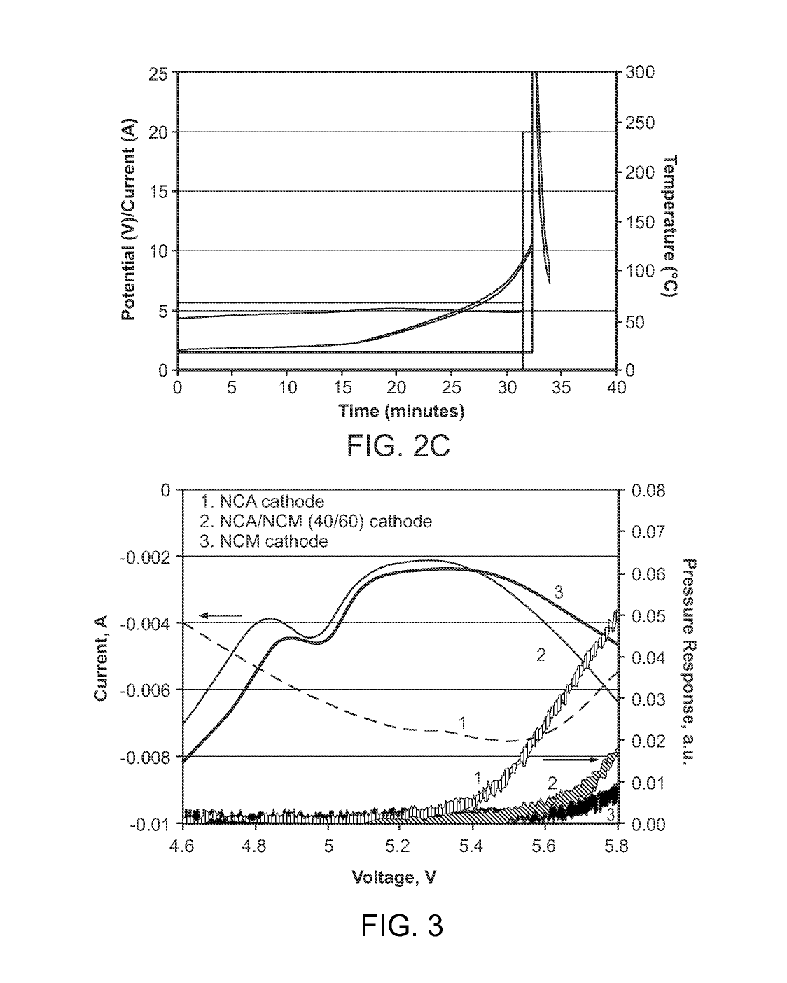

The gassing mechanism is further studied in FIG. 3. In a voltage scan study of NCA electrode in an electrolyte without a gassing agent, significant pressure is detected at around 5.3V, indicating gas producing chemical reactions. There is almost no pressure signal up to 5.6V for an NCM-containing cathode. Since, in this study, lithium metal is used, the voltage is about 0.1V higher than in lithium ion cells. A surprising finding of this invention is that the voltage of the NCA reaction would be expected to be too high to cause sufficient gassing reactions before thermal runaway in an overvoltage charge condition, however the results show that the cell using the cathode of this invention does pass the test safely. The pressure signal of a cathode of 60/40 NCM/NCA mix [by weight] is between those of NCM or NCA cathodes. The current signal (electrochemical reaction) shows the same result. This confirms that NCA in the NCA/NCM mixture will improve overcharge safety through gas release at high voltage. Generally, to further improve cell overcharge safety, a gassing agent may be included in the lithium-ion cell, however at a much lower amount than would conventionally be required and therefore with less detriment to performance of the battery. Table 1 below shows the overcharge test for cells with different cathodes and gassing additive amount. Items A through E are embodiments of the invention and items F through K are comparative.

TABLE 1

| | | | 1 C-20 V | CID | CID | | |
|---|---|---|---|---|---|---|---|
| | Cathode | wt % BP in | overvoltage | activation | activation | Max Temp | Samples |
| Sample | chemistry | electrolyte | charge result | time (min) | temp (° C.) | (° C.) | tested |
| A | NCM/NCA | 0 | PASS | 25 | 70 | 83 | 1 |
| B | NCM/NCA | 1 | PASS | 23-26 | 54-74 | 65-84 | 2 |
| C | NCM/NCA | 2 | PASS | 22.3 | 56 | 71 | 1 |
| D | NCM/NCA | 3 | PASS | 8-9 | 37-39 | 39 | 2 |
| E | NCM/NCA | 4.7 | PASS | 6-7 | 30-45 | 30-45 | 3 |
| F | NCM | 0 | FAIL | 31.6 | 108 | NA | 1 |
| G | LCO | 0 | FAIL | 25-35 | 100 | NA | 2 |
| H | LCO | 4.7 | FAIL | 23-30 | 70-90 | NA | 3 |
| I | LCO/LMO | 0 | FAIL | 28-35 | 100-120 | NA | 2 |
| J | LCO/LMO | 3 | FAIL | 20-25 | 70-90 | NA | 3 |
| K | LCO/LMO | 4.7 | PASS | 15-25 | 50-80 | 60-100 | >5 |

The data shows that only cells with NCA/NCM will pass the overvoltage charge test when no gassing agent is added into the electrolyte. In addition, for cells with NCA/NCM, as the gassing agent increases from 1 weight % to 4.7 weight %, both the CID activation time and the maximum cell temperature is lower, indicating increased margin for safety. In the examples of LCO/LMO cathode chemistry, only a BP level of 4.7% can pass the test. Typically the amount of gassing agent employed in batteries of the invention will be in an amount in a range of between about 0% to 4.7% by weight. The combination of the decomposition of NCA and gassing agent at high voltage significantly improves the overcharge safety of the lithium ion cells.

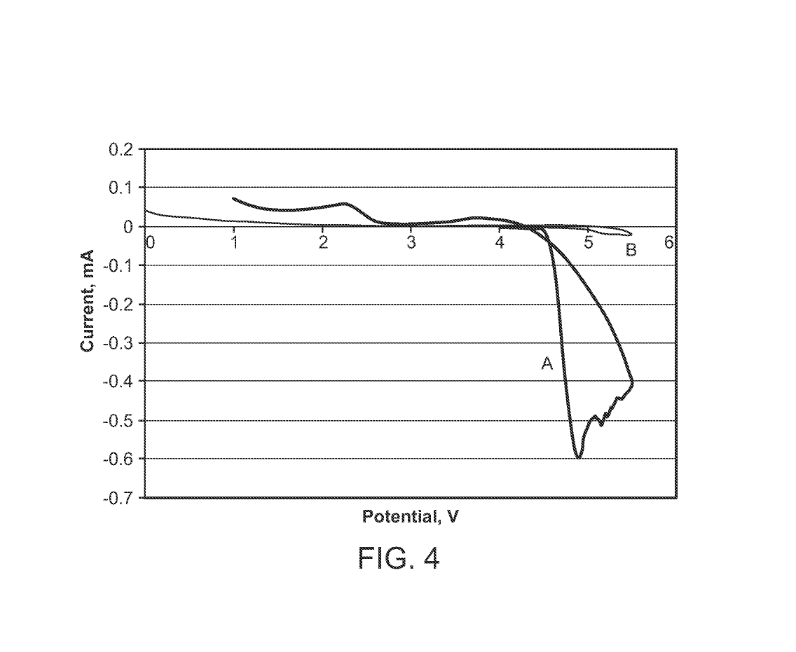

FIG. 4 shows data exhibiting the mechanism of the gassing agents typically used in lithium-ion cells to activate a CID device during an overvoltage charge condition. Using an inactive Al electrode (representing the cell cathode), the gassing additive reacts (curve A), as exhibited by the increase current flow, at a voltage between 4 to 5 V, initiating at approximately 4.4 V. Without the additive present (curve B), there is no reaction, as exhibited by the lack of current flow. Other gassing additives exhibit similar response. One would anticipate that without a gassing additive present, there would be no cause for safety protection in an overvoltage charge condition. The cell of this invention demonstrates otherwise.

A suitable current interrupt device, such as is known in the art, can be employed. Examples of suitable current interrupt devices include those disclosed in U.S. Pat. Nos. 7,838,143, 8,012,615 and 8,071,233, and U.S. patent application Ser. Nos. 13/288,454, (filed Nov. 3, 2011), 12/695,803 (filed Jan. 28, 2010) the relevant teachings of all of which are incorporated herein by reference in their entirety.

The role of the battery can or casing can be anticipated to have some influence on the results. One might expect that cylindrical cans which have less expansion of the casing will therefore require relatively less gassing agent to achieve a desired pressure increase sufficient to activate a current interrupt device, while prismatic cans which have more expansion of the casing will require relatively more gassing agent. Since prismatic cans would tend to require more gassing agent, the benefit of this invention may be more significant for this case.

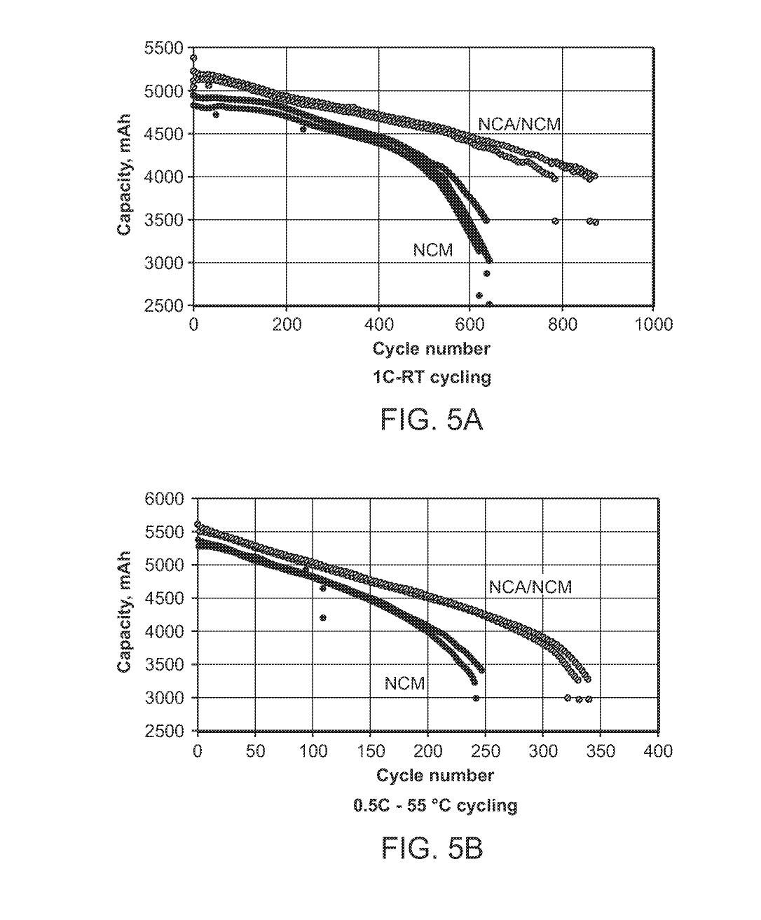

A method of forming a lithium-ion battery having a cathode that includes an active cathode material as described above is also included in the present invention. The method includes forming an active cathode material as described above. The method further includes the steps of forming a cathode electrode with the active cathode material, and forming an anode electrode in electrical contact with the cathode electrode via an electrolyte, thereby forming a lithium-ion battery. The battery casing is filled with a suitable electrolyte, such as is known in the art. Optionally, a small amount of a gassing agent is added to the electrolyte. Examples of suitable gassing agents include aromatic compounds like benzene, biphenyl (BP), cyclohexyl benzene (CHB), 3-R-thiophene, 3-chlorothiophene, furan, 2,2-di-phenylpropane, 1,2-dimethoxy-4-bromo-benzene, 2-chloro-p-xyline and 4-chloro-anisol, and 2,7-diacetyl thianthrene and their derivatives. The cycle life comparison between cells with the cathode mixture and NCM only cathode is shown in FIG. 5. The manufacturing process is the same both embodiments. As shown in FIG. 5, the cycle life at room temperature and high temperature is greatly improved with the mixed cathode.

A system that includes a battery powered device and a battery pack as described above is also included in the present invention. The present invention can be used in mobile electronic devices such as portable computers, cell phones, portable power tools, as well as in battery packs for transportation applications (for example, hybrid electric vehicle, plug-in hybrid vehicle and battery electric vehicle) and in utility energy storage (for example, distributed energy storage and load leveling applications).

The relevant portion of all citations listed herewith are incorporated by reference in their entirety.

### EXEMPLIFICATION

### Example 1

An Oblong Cell with High Capacity Having an Active Cathode Material Including Li (Ni_{0.5}Co_{0.2}Mn_{0.3})O₂ and Li(Ni_{0.8}Co_{0.15}Al_{0.05})O₂

96 wt. % mixed cathode with a weight ratio of 60:40 for Li (Ni_{0.5}Co_{0.2}Mn_{0.3}) O2: Li (Ni_{0.8}Co_{0.15}Al_{0.05}) O2, 1.5 wt. % of carbon black and 2.5 wt. % of polyvinylidene fluoride (PVDF) were mixed in N-methyl-2-pyrrolidone (NMP) under stirring. The electrode slurry was coated onto a 15 micrometer thick aluminum current collector. The aluminum current collector had a width of 56.5 mm and a length of 1603 mm. The slurry was coated on both sides of the aluminum current collector. The process media NMP was removed by heating the coated electrode at 150° C. for a few minutes. The electrode was pressed to control the coated density. The two-side coating was identical in every aspect. The thickness of the total electrode was about 125 micrometers. The composite cathode density was 3.55 g/cc. Two aluminum tabs with about a width of 3 mm, a length of 55 mm and thickness of 0.2 mm were welded onto the uncoated aluminum current collector.

95.3 wt. % graphite, 0.5 wt. % carbon black and 4.2 wt. % PVDF binder were mixed in NMP under stirring. The electrode slurry was coated onto a ten micrometer thick copper current collector. The copper current collector had a width of 58.5 mm and a length of 1648 mm. The slurry was coated on both sides of the copper current collector. The process media NMP was removed by heating the coated electrode at 150° C. for a few minutes. The electrode was pressed to control the coat density. The two-side coating was identical in every aspect. The thickness of the total electrode was about 140 micrometers. The composite anode density was 1.75 g/cc. Two nickel tabs with about a width of 3 mm, a length of 55 mm and thickness of 0.2 mm were welded onto the uncoated copper current collector.

The cathode and anode were separated by a microporous separator, with a thickness of 16 micrometers, a width of 61.5 mm and a length of about 3200 mm. They were wound into a jelly-roll. The jelly-roll was inserted into a prismatic aluminum case. The case had an external dimension of about 64 mm in height, 36 mm in width and 18 mm in thickness. The positive tab was welded onto the reception disc of a top aluminum cap, and the negative tab was welded onto a connection passing through the aluminum case. An aluminum cap was welded onto the Al case. Approximately 13 g electrolyte solution (1M LiPF₆ EC/PC/EMC/DMC in ethylene carbonate (EC), propylene carbonate (PC), dimethyl carbonate (DMC), ethyl methyl carbonate (EMC)) was added into the cell under vacuum. About 5 percent by weight gassing agent BP was included in the electrolyte to improve cell overcharge safety. The cell was completely sealed.

This cell had a capacity of 5.3 Ah at a 1.1 A discharge rate. The nominal voltage was 3.65 V. The total cell weight was approximately 92.5 g. The cell energy density was approximately 208 Wh/kg and 490 Wh/liter.

### Example 2

### Comparative Example

An Oblong Cell with High Capacity Having an Active Cathode Material Including Li(Ni_{0.5}Co_{0.2}Mn_{0.3})O2 and Li(Ni_{0.8}CO_{0.15}Al_{0.05})O₂

In this example, a prismatic cell was formed with the same anode, cathode and separator as described above in Example 1. Approximately 13 g 1M LiPF₆ EC/PC/EMC/DMC electrolyte solution was added into the cell under vacuum. No gassing agent was included in the electrolyte. The cell was then completely sealed.

This cell had a capacity of 5.3 Ah at 1.1 A discharge rate. The nominal voltage was 3.65 V. The total cell weight was approximately 92.5 g. The cell energy density was approximately 208 Wh/kg and 490 Wh/liter.

### Example 3

### Comparative Example

A Cell with an Active Cathode Material Including Li(Ni_{0.5}Co_{0.2}Mn_{0.3})O₂

In this example, a prismatic cell with an active cathode material including Li(Ni_{0.5}Co_{0.2}Mn_{0.3})O₂ was fabricated. This cell made by a similar procedure as described above in Example 1 For this example, the cathode mix included 96.0 wt. % of Li(Ni_{0.5}Co_{0.2}Mn_{0.3})O₂, 1.5 wt. % carbon black and 2.5 wt. % PVDF. The electrode slurry was coated onto a 15 micrometer thick Al current collector. The aluminum current collector had a width of 56.5 mm and a length of 1603 mm. The slurry was coated on both sides of the aluminum current collector. The process media NMP was removed by heating the coated electrode at 150° C. for a few minutes. The electrode was pressed to control the coated density. The two-side coating was identical in every aspect. The thickness of the total electrode was about 125 micrometers. The composite cathode density was 3.55 g/cc. Two aluminum tabs with about a width of 3 mm, length of 55 mm and thickness of 0.2 mm were welded onto the uncoated aluminum current collector.

95.3 wt. % of graphite, 0.5 wt. % carbon black and 4.2 wt. % PVDF binder were mixed in NMP under stirring. The electrode slurry was coated onto a 10 micrometer thick copper current collector. The copper current collector had a dimension of width of 58.5 mm and length of 1648 mm. The slurry was coated on both sides of the copper current collector. The process media NMP was removed by heating the coated electrode at 150° C. for a few minutes. The electrode was pressed to control the coated density. The two-side coating was identical in every aspect. The thickness of the total electrode was about 140 micrometers. The composite anode density was 1.75 g/cc. Two nickel tabs with about a width of 3 mm, a length of 55 mm and a thickness of 0.2 mm was welded onto the uncoated copper current collector.

The cathode and anode were separated by a microporous separator, with a thickness of 16 micrometers, a width of 61.5 mm and a length of about 3200 mm. They were wound into a jelly-roll.

The jelly-roll was inserted into a prismatic aluminum case. The case had an external dimension of about 64 mm in height, 36 mm in width and 18 mm in thickness. The positive tab was welded onto the reception disc of a top aluminum cap, and the negative tab was welded onto a connection passing through the aluminum case. An aluminum cap was welded onto the Al case. Approximately 13 g 1M LiPF₆ EC/PC/EMC/DMC electrolyte solution was added into the cell under vacuum. About 5 weight percent gassing agent was included in both additions of electrolyte to improve cell overcharge safety. The cell was completely sealed.

This cell had a capacity of 5.05 Ah at 1.1 A discharge rate. The nominal voltage was 3.65 V. The total cell weight was approximately 93.0 g. The cell energy density was approximately 197 Wh/kg and 468 Wh/liter.

### Example 4a

### Room Temperature Charge-Discharge Cycle Life Test

The cells of Examples 1, 2 and 3 were tested for ability to retain capacity during charge-discharge cycle testing as follows:

Each cell was charged with a constant current of 3.7 A to a voltage of 4.2 V and then was charged using a constant voltage of 4.2 V. The constant voltage charging was ended when the current reached 50 mA. After resting at the open circuit state for 15 minutes, it was discharged with a constant current of 2.6 A. The discharge ended when the cell voltage reached 2.75 V.

Then each cell was charged with a constant current of 3.7 A to a voltage of 4.2 V and then subsequently was charged using a constant voltage of 4.2 V. The constant voltage charging was ended when the current reached 150 mA. After resting at the open circuit state for 15 minutes, it was discharged with a constant current of 5.3 A. The discharge ended when the cell voltage reached 2.75 V. This procedure was repeated continuously to obtain cycle life data.

Cells were tested at room temperature that was controlled at 23° C. Cycle life, or the capacity retention during cycling, is one of the most important performance parameters of lithium ion cells. The cycle life was typically measured by the number of cycles when the cell capacity is 80% of the initial capacity. FIG. 4a shows that the cells with NCA/NCM (A) cathodes have much longer cycle life than those with pure NCM cathodes at room temperature conditions. This means lithium ion cells with NCA/NCM cathodes will have much longer service life in applications.

### Example 4b

### High Temperature Cycle Life Test

The cells of Examples 1, 2 and 3 were tested for ability to retain capacity during charge-discharge cycle testing at 55° C. as follows:

Each cell was charged with a constant current of 3.7 A to a voltage of 4.2 V and then was charged using a constant voltage of 4.2 V. The constant voltage charging was ended when the current reached 50 mA. After resting at the open circuit state for 15 minutes, each cell was discharged with a constant current of 2.6 A. The discharge ended when the cell voltage reached 2.75 V.

Then each cell was charged with a constant current of 3.1 A to a voltage of 4.2 V and subsequently charged using a constant voltage of 4.2 V. The constant voltage charging was ended when the current reached 150 mA. After resting at the open circuit state for 15 minutes, it was discharged with a constant power of 10 W. The discharge ended when the cell voltage reached 2.75 V. These procedures repeated continuously to obtain cycle life data.

Cells were tested in a temperature chamber set at 55° C. Cycle life at high temperature represents the capacity retention at extreme user conditions. FIG. 4b shows that the cells with NCA/NCM (A) cathodes have much longer cycle life than those with pure NCM cathodes at high temperature conditions. Since cells with NCA/NCM cathodes show better cycle life both at room temperature and high temperature (55° C.). It is expected that cells with NCA/NCM will have better service life in most applications, where the typical environment temperature is between room temperature and 55° C.

### Example 5

Overvoltage charge Abuse Test

The cells of Examples 1, 2 and 3 were abused using overvoltage charging at 5.3 A. The CID of the tested cell for Example 1 activated in about 7.5 minutes and showed a maximum temperature of about 40° C. (FIG. 2a). The CID of the tested cell for Example 2 activated in about 25 minutes and showed a maximum temperature of about 90° C. (FIG. 2b). The CID of the tested cell for Example 3 activated in about 33 minutes and showed a constant increasing temperatures until thermal runaway occurred. In this case, the activation of CID did not occur in sufficient time to prevent the cell going into thermal runaway (FIG. 2c).

The results demonstrate that the cell designed using the NCA/NCM cathode+the gassing additive shows the safest response to overvoltage charge abuse. The cell using the NCA/NCM cathode and no gassing additive remained safe but the margin of safety was reduced, as indicated by the fact that the CID took 3 times longer to activate and the cell temperature reached 90° C. The cell using only NCM cathode and including gassing additive showed a lack of safety as evident by the CID not activating in sufficient time to prevent thermal runaway.

### Example 6

### Cyclic Voltammetry (CV) Scanning

The cathodes of Examples 1 and 3, and a cathode of NCA only (Li(Ni_{0.8}Co_{0.15}Al_{0.05})O₂) were used for this study. The NCA cathode was made as follows: the cathode mix includes 96.0 wt. % of Li(Ni_{0.8}Co_{0.15}Al_{0.05})O₂, 1.5 wt. % of carbon black and 2.5 wt. % of PVDF. The electrode slurry was coated onto a 20 micrometer thick aluminum current collector. The slurry was coated on one side of the aluminum current collector. The process media NMP was removed by heating the coated electrode at 150° C. for a few minutes. The electrode was pressed to control the coated density. The thickness of the total electrode was about 75 micrometers. The composite cathode density was 3.55 g/cc. For cathodes from Examples 1 and 3, one side of the coating was removed with NMP solution before this study.

A ½ inch disc of the cathodes described above (working electrode), and a ⅝ inch disc of lithium ribbon (thickness of 0.1 mm), separated by a 20 μm microporous separator, were assembled into a special design coin cell, where a pressure gauge was connected to monitor the internal pressure in the test. Approximately 135 uL 1M LiPF₆ EC/PC/EMC/DMC electrolyte solution (without gassing agent) was added into coin cell in an argon-filled glove box. The coin cell was then subject to a voltage scan at the rate of 0.5 mV/second with a potentiostat between the open circuit voltage (˜2 V) to 5.8 V. The current and pressure was recorded during the scan.

The results are presented in FIG. 3. The results show that a cathode containing NCA will exhibit gassing reactions in voltage ranges lower than that containing NCM. A cathode combining NCA and NCM will show gassing in an intermediate range between the NCA and NCM only cathodes. Surprisingly, the voltage ranges of these gassing reactions are higher than one would expect as being required to activate a CID in sufficient time to prevent thermal runaway. However, this invention shows that the NCA containing cathode can be used to activate the CID in sufficient time to prevent thermal runaway.

The relevant teachings of all references cited herein are incorporated in their entirety.

What is claimed is:

1. A secondary lithium ion battery cell, comprising:
a) a prismatic battery can;
b) a cathode within the battery can, the cathode including a mixture of a lithium nickel cobalt manganese oxide and a lithium nickel cobalt aluminum oxide in a weight ratio of between about 0.20:0.80 and about 0.80:0.20;
c) an electrolyte within the battery can and in electrical communication with the cathode; and
d) a current interrupt device at the battery can, wherein the current interrupt device and the cathode are attenuated to trigger the current interrupt device during an overcharge condition, thereby preventing thermal runaway of the secondary lithium ion battery cell.

2. The battery of claim 1, wherein the current interrupt device will trigger when the battery is under an applied voltage in a range of greater than about 4.2 volts and equal to or less than 5.0 volts.

3. The battery of claim 2, wherein the electrolyte includes no gassing agent.

4. The battery of claim 2, wherein the electrolyte includes a gassing agent in an amount in a range equal to or less than about 4.7 weight percent.

5. The battery of claim 4, wherein the gassing agent is at least one member of the group consisting of benzene, biphenyl (BP), cyclohexyl benzene (CHB), 3-R-thiophene, 3-chlorothiophene, furan, 2,2-di-phenylpropane, 1,2-dimethoxy-4-bromo-benzene, 2-chloro-p-xyline and 4-chloro-anisol, and 2,7-diacetyl thianthrene and their derivatives.

6. The battery of claim 1, wherein the lithium nickel cobalt manganese oxide includes at least one member selected from the group consisting of Li(Ni_{0.5}Cu_{0.2}Mn_{0.3})O₂, Li(Ni_{1/3}Co_{1/3}Mn_{1/3})O₂, Li(Ni_{0.6}Co_{0.2}Mn_{0.2})O₂ and Li(N_{0.7}Co_{0.15}Mn_{0.15})O₂.

7. The battery of claim 6, wherein the lithium cobalt aluminum oxide in Li(Ni_{0.8}Co_{0.15}Al_{0.05})O₂.

8. The battery of claim 7, wherein the weight ratio of lithium nickel cobalt manganese oxide to lithium nickel cobalt aluminum oxide is about 0.60:0.40.

9. The battery of claim 8, wherein the lithium nickel cobalt manganese oxide is Li(Ni_{0.5}Co_{0.2}Mn_{0.3})O₂.

10. The battery of claim 1, wherein the battery can and the current interrupt device are aluminum and the current interrupt device is between the cathode and the battery can and in electrical communication with both the cathode and the battery can.

11. The battery of claim 1, wherein the current interrupt device will be triggered at a pressure internal to the battery can that is between about 6 and about 10 psig.

12. A battery pack, comprising a plurality of secondary lithium ion batteries in electrical communication with each other, at least a portion of the secondary lithium ion batteries comprising:
a) a prismatic battery can;
b) a cathode within the battery can, the cathode including a mixture of a lithium nickel cobalt manganese oxide and a lithium nickel cobalt aluminum oxide in a weight ratio of between about 0.20:0.80 and about 0.80:0.20;
c) an electrolyte within the battery can and in electrical communication with the cathode; and
d) a current interrupt device at the battery can, wherein the cathode and the current interrupt device are attenuated to trigger the current interrupt device during an overcharge condition, thereby preventing thermal runaway of the secondary lithium-ion battery.

13. A battery powered device, comprising at least one secondary lithium ion battery having:
a) a prismatic battery can;
b) a cathode within the battery can, the cathode including a mixture of a lithium nickel cobalt manganese oxide and a lithium nickel cobalt aluminum oxide in a weight ratio of between about 0.20:0.80 and about 0.80:0.20;
c) an electrolyte within the battery can and in electrical communication with the cathode; and
d) a current interrupt device at the battery can, wherein the cathode and the current interrupt device are attenuated to trigger the current interrupt device during an overcharge condition, thereby preventing thermal runaway of the secondary lithium-ion battery.
